(19) United States
(12) Patent Application Publication
(10) Pub. No.: US 2011/0140916 A1
(43) Pub. Date: Jun. 16, 2011

(54) Radar warning device with GPS wireless transmission and drive recording function

(76) Inventor: Yuei-Yi Kao, Taibao City (TW)

(21) Appl. No.: 12/654,179

(22) Filed: Dec. 14, 2009

(51) Int. Cl. G08G 1/00; H04N 7/18

(52) U.S. Cl. 340/902; 348/148; 348/E07.085

(57) ABSTRACT

A radar warning device with GPS wireless transmission and drive recording functions is revealed. The radar warning device includes a host processor respectively connected with a Global Position System (GPS) module for receiving signals from GPS satellites and providing reliable positioning of vehicles to drivers, a speed-detection warning unit that detects speed detectors on roads, and a drive recorder that takes images inside and outside the car. Moreover, the drive recorder is disposed with a kinematic sensor that senses gravity value variations and data along X-axis, Y-axis and Z-axis so as to determine who is responsible for the car accident. Thereby the radar warning device not only has GPS positioning, radar detection, image capture inside and outside the car and driving condition recording, but also automatically informs related people to deal with events immediately when the radar warning device detects that a car accident occurs or the car is stolen.

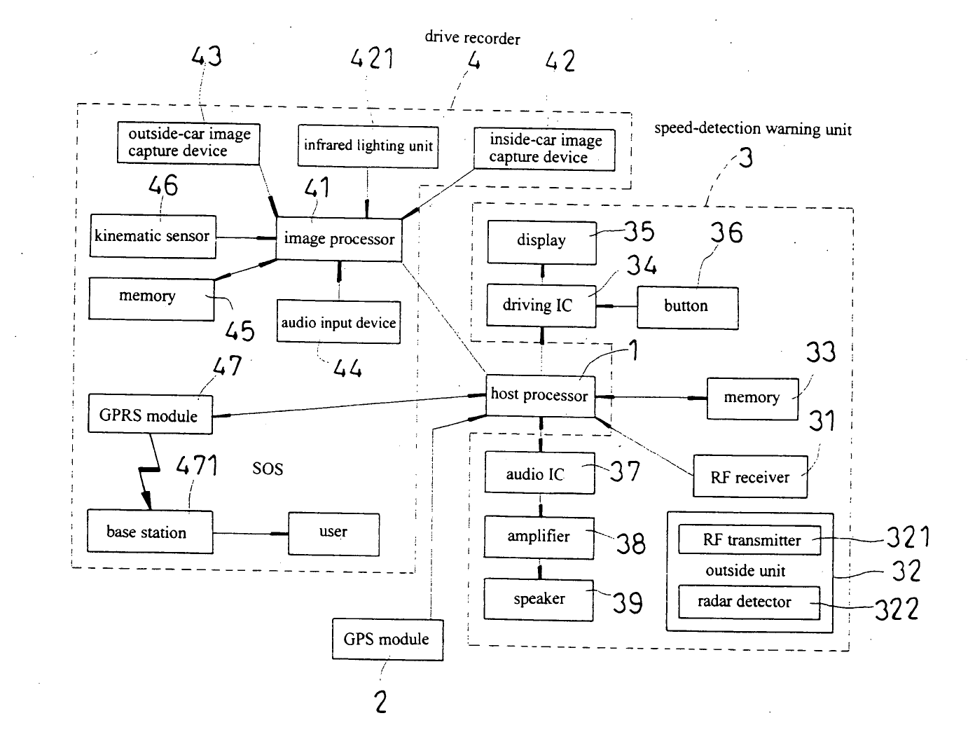

### BACKGROUND OF THE INVENTION

1. Fields of the invention

The present invention relates to a radar warning device with GPS wireless transmission and drive recording functions, especially to a radar warning device that not only has GPS positioning, radar detection, and image capture functions, but also can take images inside and outside the car and record driving conditions. Moreover, the radar warning device can also automatically inform related people to deal with events immediately when the radar warning device detects that a car accident occurs or the car is stolen.

2. Descriptions of Related Art

Refer to Taiwanese Pat. No. 1248520 “radar and laser detector with GPS receiver and wireless communication function”, published on Feb. 1, 2006, a radar and laser detector is disclosed. The radar and laser detector includes a signal receiving module, and an information display module. The signal receiving module consists of a signal processing unit for detecting a signal received by a horn antenna, a laser receiving unit for receiving a laser signal, a central processing unit and an information transmission unit. The central processing unit is to control detection of the received signal through the signal processing unit and the laser receiving unit, analyze of the detected signal, and output the information data of the detected signal while the information transmission unit is for sending the information data output from the central processing unit in a wireless way. As to the information display module, it is composed of an information receiving unit for receiving the information data sent wirelessly from the information transmission unit of the signal receiving module, a GPS engine that senses GPS data from a satellite, a memory for storage of coordinate data indicating positions of a moving vehicle, an audible indicating unit that outputs the information received by the information receiving unit or obtained by searching of the GPS engine in an audible way, a visual display unit that displays the information received by the information receiving unit or obtained by searching of the GPS engine in an visual way, and central processing unit that controls the audible indicating unit as well as the visual display unit according to the information received by the information receiving unit or obtained by searching of the GPS engine. Thus the device offers correct traffic information to drivers.

However, the radar and laser detector only gives a single function of detection of speed detectors arranged on roads. There is no other function. Now most of products on the market possess multiple functions so that the functionality of the radar and laser detector is a bit poor and the market competitiveness of the product is reduced. Thus people lose interests in the product.

### SUMMARY OF THE INVENTION

Therefore it is a primary object of the present invention to provide a radar warning device with GPS wireless transmission and drive recording functions. The radar waning device not only has GPS positioning, radar detection, and image capture functions, but also can take images inside and outside the car and record driving conditions so as to determine who is responsible for the accident when a car accident occurs. Moreover, the radar warning device can also automatically inform related people to deal with events immediately when the radar warning device detects that a car accident occurs or the car is stolen.

In order to achieve above object, a radar warning device with GPS wireless transmission and drive recording functions of the present invention includes a host processor that is respectively connected with a GPS module, a speed-detection warning unit and a drive recorder. The GPS (Global Position System) module is used to receive signals from GPS satellites and provide reliable positioning of vehicles to drivers. The speed-detection warning unit uses a radar detector to detect speed detectors on roads. The drive recorder includes an inside-car image capture device and an outside-car image capture device respectively for recording conditions inside and outside the car during the movement of the car. At the same time, the drive recorder is arranged with a kinematic sensor that senses gravity acceleration (G-value) variations and data along X-axis, Y-axis and Z-axis during movement of the car for checking whether the car accident occurs.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

The FIGURE is a block diagram of an embodiment according to the present invention.

### DETAILED DESCRIPTION OF THE PREFERRED EMBODIMENT

Refer to the FIGURE, a radar warning device of the present invention includes a host processor 1 connected with a GPS module 2, a speed-detection warning unit 3 and a drive recorder 4.

The GPS (Global Position System) module 2 receives signals from GPS satellites and provides reliable positioning of vehicles to drivers.

The speed-detection warning unit 3 includes a radio frequency (RF) receiver 31 that is connected with a host processor 1 and is used for receiving signals from a RF transmitter 321 of an outside unit 32. The RF transmitter 321 of the outside unit 32 is connected with a radar detector 322 that detects speed detectors on roads. In the speed-detection warning unit 3, a memory. 33 connected with the host processor 1 is for storage of coordinates data. Moreover, a driving IC (integrated circuit) 34 for driving a display 35 to show various data is connected with the host processor 1 correspondingly. The driving IC 34 also connects with at least one button 36 for switching displaying mode of the display 35. Furthermore, the host processor 1 is connected with an audio IC 37. The audio IC 37 is connected with a speaker 39 through an amplifier 38 so as to broadcast various warning signals by the speaker 39.

The drive recorder 4 includes an image processor 41 that is connected with the host processor 1. The image processor 41 is also connected with an inside-car image capture device 42 as well as an outside-car image capture device 43 respectively for taking images inside and outside the car. The image processor 41 is connected with an infrared lighting unit 421 for providing supplemental infrared illumination. When it's dark or dim in the car, the inside-car image capture device 42 can still take clear images inside the car by means of the infrared lighting unit 421. Moreover, the image processor 41 is connected with an audio input device 44 such as a microphone. Thus sounds inside the car are also recorded by the audio input device 44 simultaneously when the inside-car image capture device 42 takes images inside the car. The image processor 41 is connected with a memory 45 for storage of data captured by the inside-car image capture device 42 and the outside-car image capture device 43. Furthermore, the image processor 41 is connected with a kinematic sensor 46 that senses gravity acceleration (G-value) variations and data along X-axis, Y-axis and Z-axis during movement of the car. Thus who is responsible for the accident can be figured out and the content of images captured by the inside-car image capture device 42 as well as the outside-car image capture device 43 and saved in the memory 45 within that period of time (the car movement) is left, not overwritten. In addition, the drive recorder 4 is further disposed with a GPRS (general packet radio service) module 47 connected with the host processor 1. The GPRS module 47 is wireless connected with base stations 471 so as to contact related people through the base stations 471.

Thereby, during the driving process, the GPS (Global Position System) module 2 receives signals from GPS satellites and provides reliable positioning of vehicles, driving direction, and speed to drivers. It also sends coordinate data related to roadside objects or road conditions such as fixed speed detection locations, danger spots on the roads, accident-prone Locations, schools, airports or other public facilities to the memory 33 of the speed-detection warning unit 3. The coordinate data is saved therein and is shown to the driver by the display 35. Moreover, the RF receiver 31 of the speed-detection warning unit 3 receives signals from the RF transmitter 321 of the outside unit 32. When the radar detector 322 of the outside unit 32 detects the speed detector on road, a signal is sent by the RF transmitter 321, received by the RF receiver 31, and transmitted to the host processor 1. Then the signal is through the driving IC 34 to be displayed on the display 35 and is also through the audio IC 37, the amplifier 38 to the speaker 39 for giving a warning signal. Moreover, the inside-car image capture device 42 and the outside-car image capture device 43 of the drive recorder 4 respectively take images inside and outside the car. When it's dark and visibility is poor in the car, the inside-car image capture device 42 can still work well with the infrared lighting unit 421. At the same time, sounds inside the car are input by the audio input device 44. The image files captured are saved in the memory 45. The driving directions, speeds, coordinates and gravity acceleration (G-value) variations and data along X-axis, Y-axis and Z-axis of the car are also saved in the memory 45 simultaneously. The storage capacity of the memory 45 is limited so that existed data is overwritten by newly received data when the storage capacity is full.

When the car is stopped, the gravity acceleration (G value) in a horizontal direction is 0 G. The gravity acceleration (G value) changes when the car starts moving. While accelerating and braking, the G value along the Y-axis changes. The G-value along the X-axis changes while making turns. As to the G-value along the Z-axis, it changes when the car jumps or moves vertically. Generally, the variation along X-axis, Y-axis and Z-axis is a stable curve. When the curve becomes steeper, the host processor 1 records the present position and driving information and continuously detects whether the car still moves. If the car is still driving normally, this represents that there is no car accident and the host processor 1 will not run following procedures. Once the car is not in the driving mode, this represents that a car accidents occurs. Now the image processor 41 controls the memory to prevent images captured within a certain interval before and after the car accident saved in the memory from being overwritten and leave the images. At the same time, a distress signal is sent automatically or by users, through the GPRS module 47 to connect with the base stations. Thus longitude and latitude data is sent back to a server. By searching of the map and positioning of the GPS module 2, the longitude and latitude data of the location of the car accident is obtained and is converted to relative position information that is sent to related people for dealing with the car accidents. For example, the data related to the location of the car accident that is in a certain direction, about some meters away from a road section or a building as well messages regarding the car accident is sent by the wireless connection with the base station 471 through the GPRS module 47 of the drive recorder 4.

In addition, when the car is not in use, placed outdoors or on public parking, an electric fence system is activated automatically. Once the car is stolen by unauthorized persons, the system automatically operates an alarm signal because the car is out of a preset area. Through the GPRS module 47 and the connection with the base stations 471, the longitude and latitude data is sent back to the server. By map searching and the GPS module 2 positioning, the longitude and latitude data of the location of the car is obtained and is converted to relative position information that is sent to related people for dealing with the burglary. For example, the data regarding the location of the car that is in a certain direction, about some meters away from a road section or a building as well message regarding the car stealing is sent. At the same time, the inside-car image capture device 42 of the drive recorder 4 continues to capture images. Through the GPRS module 47, the radar warning device is connected with the base station 471 wirelessly so as to transmit the signals regarding location of the car obtained by GPS module 2 positioning as well as inside-car images to the people related to the event such as policemen. Thus the people know the location of the car and the images of the thief so that they can take the corresponding measures.

In summary, compared with the structure of the device available now, the present invention can help to figure out who is responsible for the accident when a car accident occurs. The radar warning device not only has functions of GPS positioning, radar detection, and image capture, but also can take images inside and outside the car and record driving conditions. Moreover, the radar warning device can also automatically inform related people to deal with events immediately when the radar warning device detects that a car accident occurs or the car is stolen.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A radar warning device with GPS wireless transmission and drive recording functions comprising: a host processor, and
a drive recorder connected with the host processor and having an image processor, an inside-car image capture device, an outside-car image capture device, a memory and a GPRS module respectively;
the image processor connected with the host processor, the inside-car image capture device, the outside-car image capture device and the memory respectively;
the inside-car image capture device and the outside-car image capture device respectively taking images inside the outside a car;
the memory saving the images captured by the inside-car image capture device and the outside-car image capture device;
the GPRS module connected with the host processor and wirelessly connected with base stations so as to contact people related by the base stations.

2. The device as claimed in claim 1, wherein the image processor of the drive recorder is connected with an infrared lighting unit for providing supplemental infrared illumination to the inside-car image capture device so that the inside-car image capture device takes images clearly inside the car even the light is dim and visibility is poor in the car.

3. The device as claimed in claim 1, wherein the image processor of the drive recorder is connected with an audio input device for recording sounds inside the car simultaneously when the inside-car image capture device takes images inside the car.

4. The device as claimed in claim 3, wherein the audio input device is a microphone.

5. The device as claimed in claim 1, wherein the image processor of the drive recorder is connected with a kinematic sensor that senses gravity value variations and data along X-axis, Y-axis and Z-axis for figuring out who is responsible for a car accident and leaving images captured by the inside-car image capture device as well as the outside-car image capture device within a time interval before and after the car accident saved in the memory, not overwritten.

6. The device as claimed in claim 1, wherein the host processor is connected with a Global Position System (GPS) module and a speed-detection warning unit respectively; the GPS module is for receiving signals from GPS satellites and providing vehicle positioning while the speed-detection warning unit includes a radio frequency (RF) receiver connected with the host processor; the RF receiver receives signals from a RF transmitter of an outside unit of the car and the RF transmitter of the outside unit is connected with a radar detector that detects speed detectors on roads.

7. The device as claimed in claim 6, wherein the speed-detection warning unit is disposed with a memory that is connected with the host processor correspondingly and is used for storage of coordinate data.

8. The device as claimed in claim 6, wherein the speed-detection warning unit is arranged with a driving integrated circuit (IC) that is connected with the host processor correspondingly and is used for driving a display to show various data; the driving IC is also connected with at least one button for switching displaying mode of the display.

9. The device as claimed in claim 6, wherein the speed-detection warning unit is disposed with an audio IC that is connected with the host processor correspondingly and the audio IC is further connected with a speaker through an amplified so as to broadcast various warning signals by the speaker.
